(19) United States
(12) Patent Application Publication
(10) Pub. No.: US 2024/0406202 A1
(43) Pub. Date: Dec. 5, 2024

(54) ONLINE DATING SCHEDULING AND MATCHING PLATFORM

(71) Applicant: Dominic Bayless, Circle, CA (US)

(72) Inventor: Dominic Bayless, Circle, CA (US)

(21) Appl. No.: 18/732,337

(22) Filed: Jun. 3, 2024

Related U.S. Application Data
(60) Provisional application No. 63/505,927, filed on Jun. 2, 2023.

(51) Int. Cl. H04L 9/40; G06F 8/65; G06F 9/451; G06Q 50/00

(52) U.S. Cl. CPC H04L 63/1425; G06F 8/65; G06F 9/451; G06Q 50/01

(57) ABSTRACT

An online platform configured to facilitate the matching of users together on similar timelines based on their shared preferences for interests and locations, the platform being configured to prioritize matches in accordance with time (day, hours, minutes) at which they are available to chat and/or video conference. An automatic background generator enables users to depict their video call background to a place or topic to which both users share, helping to facilitate conversation during the date at the specific, agreed-upon time. The online dating platform is an artificial intelligence-enhanced dating application that integrates advanced behavior detection systems to identify and mitigate toxic or disruptive behavior during text and video interactions. The system employs AI to monitor and analyze user interactions, both textual and visual, flagging and reporting inappropriate behavior. The application tracks user reports, assigns unique user IDs for efficient monitoring, and implements content updates to enhance user experience.

This application is a non-provisional patent application of provisional patent application No. 63/505,927, filed on Jun. 2, 2023, and priority is claimed thereto.

### FIELD OF THE PRESENT INVENTION

The present invention relates to the field of online dating, and more specifically relates to a system and platform configured to facilitate the scheduling and matching of users to one another based off on interests and time available for an online video call to be enacted as an online date. The platform employs artificial intelligence and enables users to quickly and easily match with people who have shared interests, and place them in a virtual video chat room equipped with customized backgrounds that correspond to their shared location or topic of interest.

### BACKGROUND OF THE PRESENT INVENTION

Online dating can be a time-consuming activity. Combing through online profiles is often laborious, and it frustrating to many users when they eventually find someone they wish to contact, only to find that their schedules do not match up, or they do not genuinely have shared interest.

Unfortunately, most online dating platforms fail to accommodate scheduling into their criteria for matches and leave the actual scheduling of dates up to the users if/when they find each other. This can prove problematic for some users who find what appears to be the perfect match, only to find out later that they will never have a time at which both users are free to chat or video call. If there were a dating platform that put scheduling at the forefront, which enabled users to search for potential dates based on availability (time, date) in addition to shared interest and proximity filters, more users could have more effective dates and less time would be wasted by users seeking to find individuals who ultimately are not willing to put in a time at which they will make themselves available to meet up.

Further, these platforms often face challenges related to user behavior, including harassment, abuse, and inappropriate conduct. Addressing these issues is crucial to ensuring a safe and enjoyable experience for all users. Current solutions lack effective mechanisms for real-time detection and management of toxic behavior during both text and video interactions. If there were a way in which artificial intelligence could be employed to mitigate abusive and inappropriate behavior, users would benefit from a safer online dating experience.

Thus, there is a need for a new online dating platform configured to match users based not only on shared interest and proximity, but on a day and time at which they would be willing to have a chat or video call, enacted as a virtual date in real-time. Such a platform preferably enables users to dictate to the platform a specific time and date at which they are willing to have a date (text chat and/or video chat). Likewise, the platform is equipped to also allow users to select dates from those that have proposed the specific time and date which aligns with their own availability. Further, such a platform and system preferably penalizes users who miss their scheduled dates more than three times, helping to provide accountability to the users, and minimize wasted time. The platform employs artificial intelligence (AI) to mitigate challenges relating to user behavior, including harassment, abuse, and inappropriate conduct. The present invention addresses these challenges by incorporating the AI into a dating application, designed to detect, report, and manage toxic or disruptive behavior in real-time.

### SUMMARY OF THE PRESENT INVENTION

The present invention is an online dating and video-dating platform configured to facilitate the matching of individuals based on common interests, common favorite places, and common times at which they may connect during a live video call. The platform is configured to enable users to propose a time for a date, referenced as a time-setter. Correspondingly, users, referenced as time-seekers, can browse available timelines of potential dates with which they have shared interest. Time-seekers may seek, therefore viewing whatever times they feel fit their schedule. A dynamic background for video-dates is enacted by the platform of the present invention, enabling users to deliberately choose, or have the platform automatically select, pertinent background imagery to be shown to their date during their video call. If the platform selects the background imagery for the daters, information is pulled from shared interests between the two users, making the background relevant to helping to provide a topic of conversation for the date.

Artificial intelligence is employed to monitor behavior of users during dates and communications within the platform. Natural Language Processing (NLP) and computer vision are used to analyze interactions between users on dates. Further, users are provided the option to report inappropriate behavior during or after dates and/or interactions on the platform of the present invention.

Key features of the present invention preferably include:

### AI-Powered Behavior Detection:

The AI system monitors both text messages and video calls for signs of inappropriate behavior. It utilizes natural language processing (NLP) and computer vision techniques to analyze interactions. The AI detects verbal abuse, hate speech, and inappropriate visual content such as nudity or gestures.

### User Reporting and Tracking:

Users can report inappropriate behavior during or after interactions. Each user is assigned a unique ID for efficient tracking of reports and behavioral patterns. The system logs all reports and uses AI to aggregate and analyze data, identifying repeat offenders.

### Automated Response and Moderation:

The AI assigns severity levels to incidents based on predefined keywords and behavior patterns. For severe or repeated offenses, the system can automatically suspend or ban users.

Moderators receive detailed reports generated by the AI for review and final decision-making.

### Content Updates and User Experience Enhancements:

Monthly updates introduce new backgrounds, interactive elements, and features to enhance video call experiences. The application ensures a fresh and engaging environment, encouraging positive interactions.

The following brief and detailed descriptions of the drawings are provided to explain possible embodiments of the present invention but are not provided to limit the scope of the present invention as expressed herein this summary section.

### BRIEF DESCRIPTION OF DRAWINGS OF THE PRESENT INVENTION

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 shows a screenshot of an embodiment of the platform of the present invention, depicting a scheduler screen.

FIG. 2 exhibits a flow chart detailing the process of use of the platform and system of the present invention by a user.

FIG. 3 depicts an example of a Time-seeker screen as the user reviews potential dates which have been proposed by time-setter users.

FIG. 4 depicts an example of a Time-setter screen as the user sets up a date to be proposed, including setting the time of the date, the duration of the date, and the background/setting for the date.

FIG. 5 shows an example of the date screen of the present invention, depicting two users on a live date as scheduled and matched on the system and platform of the present invention.

FIG. 6 shows an example of a python script detailing the text analysis module of the present invention.

FIG. 7 shows an example of a python script detailing the video analysis module of the present invention.

FIG. 8 shows an example of a python script detailing the reporting feature of the present invention.

FIG. 9 shows an example of a python script detailing the AI-driven moderation (severity score assignment) of the present invention.

### DETAILED DESCRIPTION OF THE PRESENT INVENTION

The present invention is a modular fence consisting of at least one module (10). Each of the at least one modules (10) includes boards (20) and posts (30). Additionally, each module (10) is preferably six feet tall by eight feet long (or six feet tall by six feet long). The at least one module (10) of the present invention, when properly erected, meets the Miami Dade County wind load requirement, the highest standard in America. As such, the at least one module (10) of the present invention is configured to withstand up to 115 MPH gusts and sustained winds of up to 75 mph.

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention is an online platform (10) and system configured to facilitate the matching of individuals for one or more online dates. Matches are enacted based on shared availability (including time of day and day of the week), shared interests, and proximity to one another.

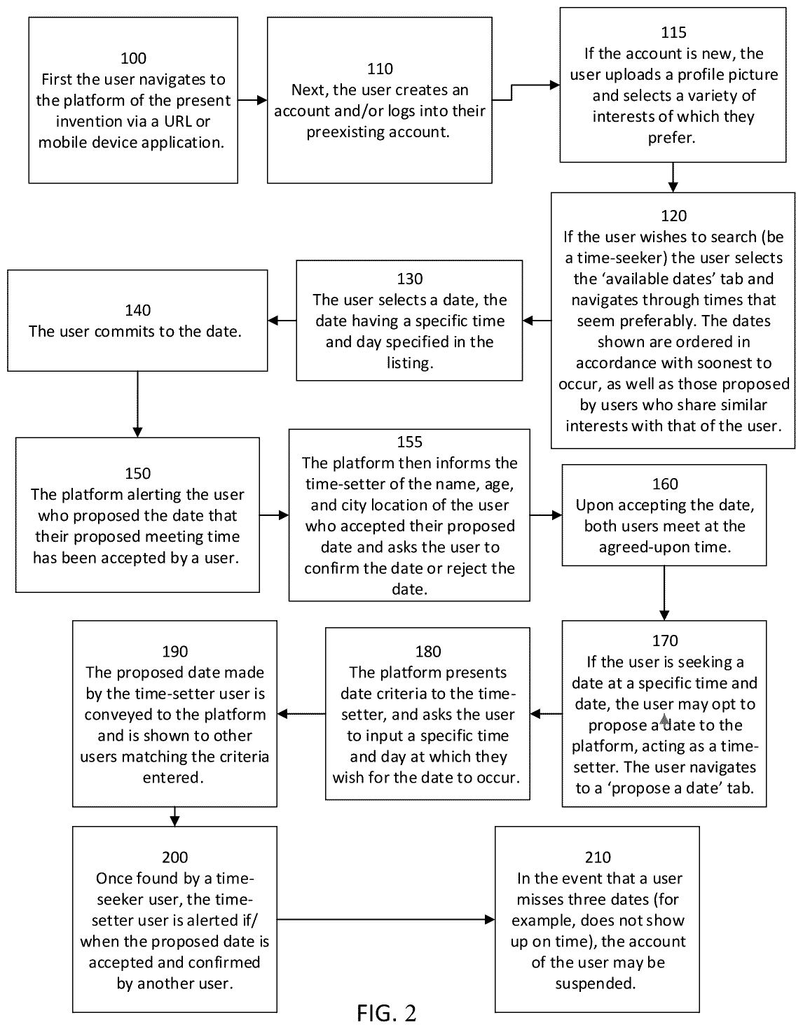

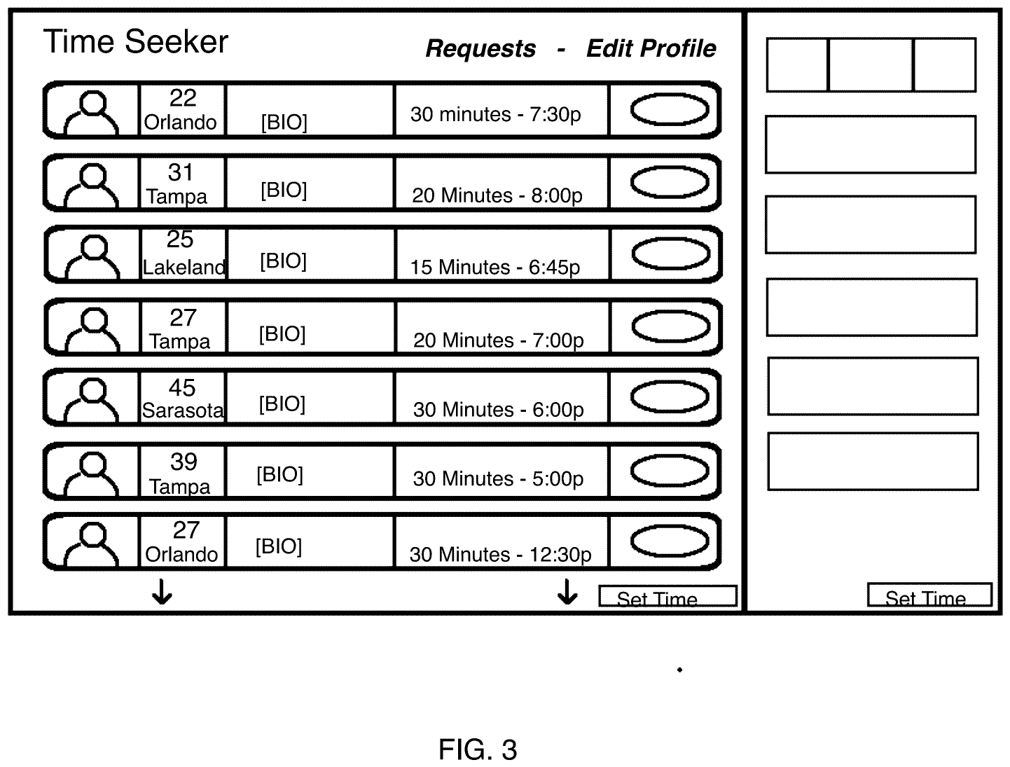

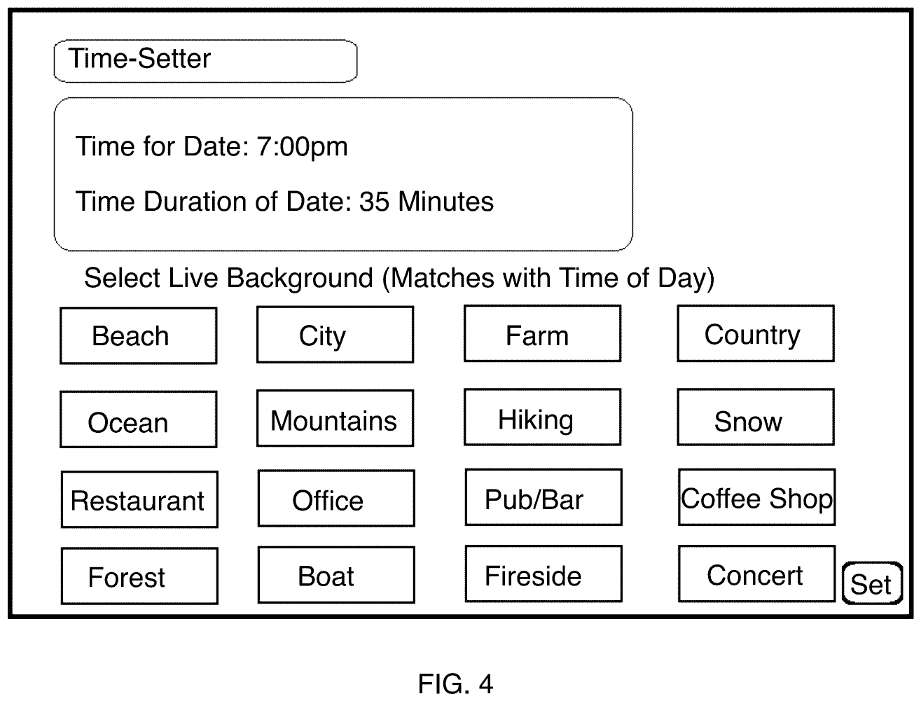

As outlined in FIG. 2, the process of use of the platform and system of the present invention by a user is preferably as follows:
1. First the user navigates to the platform of the present invention via a URL or mobile device application. (100)
2. Next, the user creates an account and/or logs into their preexisting account. (110)
3. If the account is new, the user uploads a profile picture and selects a variety of interests of which they prefer. (115)
4. If the user wishes to search (be a time-seeker) the user selects the ‘available dates’ tab and navigates through times that seem preferably. The dates shown are ordered in accordance with soonest to occur, as well as those proposed by users who share similar interests with that of the user. (120)
5. The user selects a date, the date having a specific time and day specified in the listing. (130)
6. The user commits to the date. (140)
7. The platform alerting the user who proposed the date that their proposed meeting time has been accepted by a user. (150)
8. The platform then informs the time-setter of the name, age, and city location of the user who accepted their proposed date and asks the user to confirm the date or reject the date. (155)
9. Upon accepting the date, both users meet at the agreed-upon time. (160) Meetings can occur via text, or preferably via a video conference. The video conference software is preferably embedded within the platform of the present invention, or may be conducted externally such as through a service or application such as Zoom™, Google™ Meet, or similar service. If embedded via API, the video conference software may optionally propose pertinent backgrounds to the user(s) based on their shared interests (such as a location) to foster communication during the date.
10. If the user is seeking a date at a specific time and date, the user may opt to propose a date to the platform, acting as a time-setter. The user navigates to a ‘propose a date’ tab. (170)
11. The platform presents date criteria to the time-setter, and asks the user to input a specific time and day at which they wish for the date to occur. (180) The user may also input additional criteria as to who may accept the date in some embodiments of the present invention.
12. The proposed date made by the time-setter user is conveyed to the platform and is shown to other users matching the criteria entered. (190)
13. Once found by a time-seeker user, the time-setter user is alerted if/when the proposed date is accepted and confirmed by another user. (200)
14. In the event that a user misses three dates (for example, does not show up on time), the account of the user may be suspended. (210)

It should be noted that, within minutes or even hours, a user is preferably able to change from being a time-seeker to a time-setter (or vice versa) if a date in unable to be found. The platform (10) is preferably configured to warn the user two hours beforehand if a person has yet to commit to the user's proposed date/time. At that time, the user may opt to cancel or change time or seek for more times for which they are available. This allows for flexibility for people to find dates thoroughly and with as little trouble as possible.

Additionally, if a time-setter or time-seeker has a date with another user that is running into another date that has been subsequently scheduled, the dater in the date/meeting that is running into another date/meeting would have the option to send a message to that dater's second date letting them know as to why that dater is running late. The second dater has the option to wait or to cancel the date.

It should be noted that the time-setter user sets a time limit for the date. Time extensions are provided in five-minute intervals, such as 10, 15, 20, 25 minutes, etc. Likewise, the time-setter can select any time of day for the start of the date. Further, during date creation, the time-setter can select a desired background. As previously noted, the system and platform of the present invention is preferably available as a mobile device application and a website, however actual video dates are preferably solely enacted on the website embodiment of the present invention. Calls are connected and executed on the website via conventional video conference APIs. In contrast, the mobile device application is equipped to convey notifications to the user pertaining to upcoming dates, as well as if the user's request for a date has been accepted (as a time-seeker) or if the user receives a request as a time-setter.

In preferred embodiments of the present invention, the time-setter user is preferably able to view the profile of the user who has requested their preferred date time range (i.e. requests from other users). If the user is a time-seeker, the only users capable of viewing their profile are those whose time they have requested. Further, in preferred embodiments of the present invention, the time-setter user is provided the option to text message (MMS, SMS, iMessage, etc.) the time-seeker user(s) who have sent a request. This allows for the time-setter to text message all users requesting his/her time, and the time-seekers to text multiple people they have requested if (and only if) the time-setter texts them first. After the initial text is sent from the time-setter, such as to confirm the date, they are free to chat. A simplified order of the texting attributes of the system and platform of the present invention is as follows:
1. Time-seeker sends a request to a time-setter.
2. Time-setter accepts the request, and text messages the time-seeker to confirm the details of the date.
3. Then, the date is set.

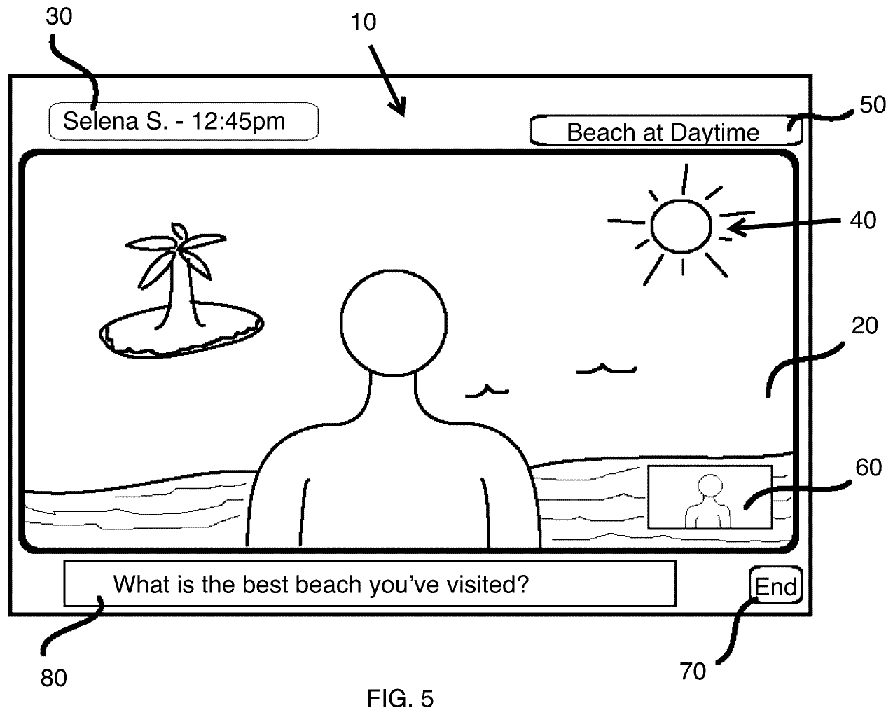

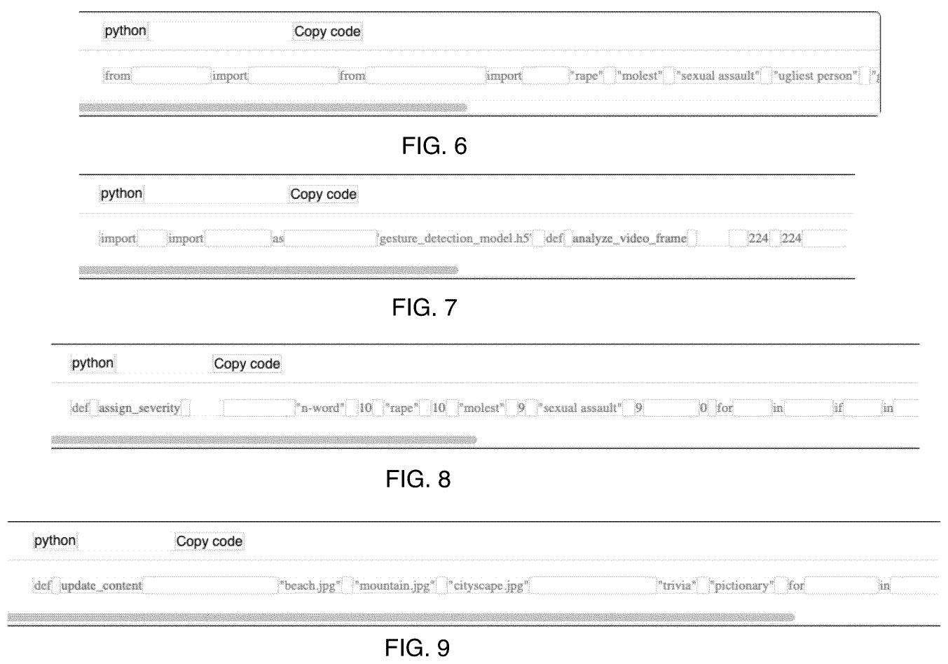

As depicted in FIG. 5, dates conducted between a time-setter user and a time-seeker user appear on a video date screen (20). On the video date screen (20), date information is presented in a date information section (30) which reminds each user of the name of their match, as well as the time of the arranged date. A selected, time-sensitive background (40) is shown behind each user, and the name of the background is shown in a background information box (50). The matched user is shown in the large display, and a thumbnail display (60) shows the user a live feed of themselves. An End Date button (70) is preferably present to facilitate early termination of a date if desired. A prompt or question is preferably shown to one or both users of the date within a prompt box (80) on the video date screen (20). The prompt or question is geared to stimulate conversation between the pair during the date. The prompt or question may or may not be related to the background depicted.

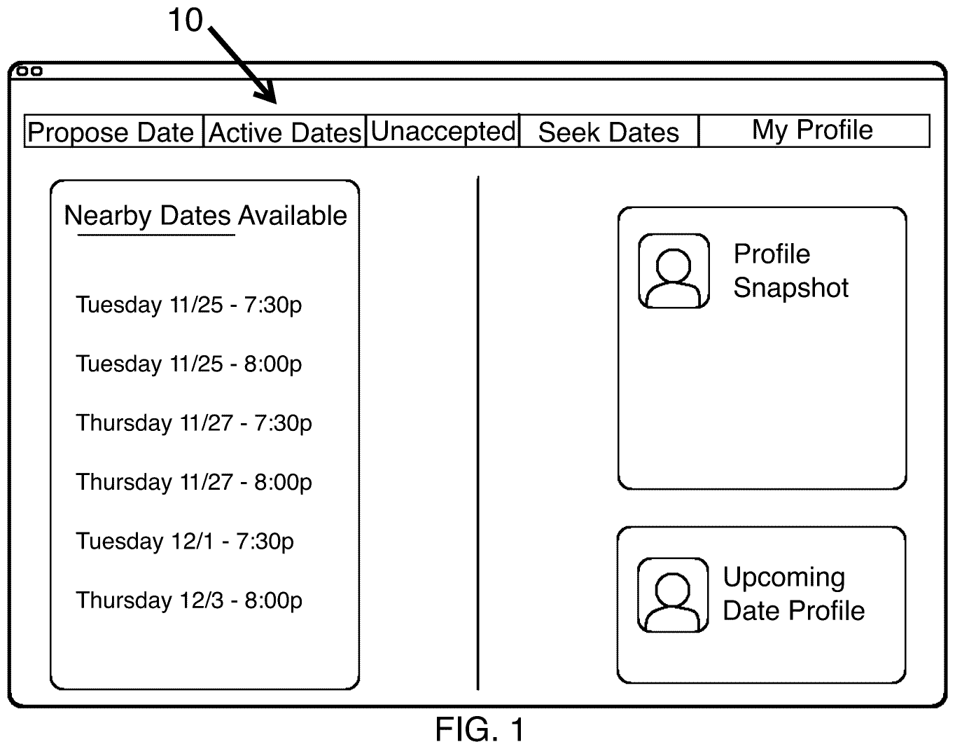

Further, it should be noted that alternate embodiments of the present invention may exhibit different UI elements depicted on the platform (10) than those depicted in FIG. 1 and FIG. 5. Further, alternate embodiments of the present invention may exhibit multiple mechanisms by which users may select their optimal background for the video date than shown in FIG. 1. The profile of each user preferably consists of a few photos, a short biography, a statement of age of the user, a listing of interests, and the city in which the user lives. However, alternate embodiments of the present invention may be configured to exhibit additional data on the profile of each user.

Additionally, it should be noted that preferred embodiments of the present invention are equipped with elements which employ machine learning (Artificial Intelligence, A.I.) to enhance and expedite the matching experience for users. For example, when a user views a list of times set by time-setter users, the AI of the system and platform of the present invention is able to order the users who set and confirm dates quickly at the top of the list. Therefore, if a time-setter user sets a time for a date at 7:00 PM, and confirms a match 15 minutes later, that user will be placed at the top of the list for other users who also confirm dates within the first 30 minutes of proposing a date time.

Further, the platform and system of the present invention is configured to employ AI to facilitate automated recommendations to users. Recommendations posited by the platform may include, but are not limited to: recommending similar users who tend to have dates which last approximately the same length of time as those of the user. Therefore, if a given user generally enjoys dates that last around 30 minutes, the system will provide recommendations, shown in a “recommendations tab,” of users who also have dates that last approximately 30 minutes.

AI features may also include a chemistry match which will be shown when the user opts as the role of a time-setter. In such instances, the user will be shown a number of requests, and of those requests, ones from users having similar “chemistry” to that of the user will be shown first (at the top of the list). Chemistry may be defined by the system in a variety of ways, however it preferably includes, but is not limited to: similar length of date, similar interests, similar proximity, and same language. Further, the system is preferably configured to automatically provide time-of-day insight to the selected, or automatically determined, background for the video date. For instance, the background would show a night-time scene if the date is to occur after sundown, and a daylight scene if the date is to occur during the day.

Additionally, in some embodiments of the present invention, the platform and system are preferably configured to assist users during their dates by positing questions to the users during their date that relate to both users, such as questions pertaining to shared interests based on the state of both users' profiles prior to the initiation of the date. In short, it should be noted that the platform and system of the present invention exhibits the following attributes and properties:

### System Architecture:

a. The dating application consists of a frontend user interface (UI) and a backend AI engine.
b. The frontend UI is designed for user interaction (referenced as the platform), while the backend AI engine processes data and handles behavior detection.
c. The backend AI engine is divided into three main modules: Text Analysis, Video Analysis, and Report Management.

### Behavior Detection Mechanism:

a. Text Analysis Module:
   i. This module uses NLP algorithms to scan messages for harmful language.
   ii. The module includes a database of predefined keywords and phrases indicating abusive or inappropriate behavior, such as “rape,” “molest,” “sexual assault,” “You're the ugliest person I've ever seen,” and “I am going to find you and . . . ”
   iii. NLP techniques such as sentiment analysis and keyword matching are employed to detect toxic language.
   iv. When a keyword or phrase is detected, the system flags the message for further review.
b. Video Analysis Module:
   i. This module uses computer vision techniques to analyze live video streams.
   ii. It employs object detection and gesture recognition algorithms to identify inappropriate visual content.
   iii. The system can detect nudity, obscene gestures, and other forms of visual harassment.
   iv. When inappropriate content is detected, the system flags the video interaction for review.

### User Report Management:

a. Users can report inappropriate behavior directly through the application's interface by selecting a “Report” button.
b. The report form allows users to specify the type of inappropriate behavior (e.g., verbal abuse, visual harassment) and provide additional details.
c. Each user is assigned a unique ID upon registration, which is used to track all interactions and reports associated with that user.
d. The system logs each report in a database, associating it with the user's unique ID for comprehensive tracking.

### AI-Driven Moderation:

a. The AI system assigns severity scores to reported incidents based on predefined criteria and patterns.
b. The criteria include the frequency of reports, severity of language or actions, and context of the interaction.
c. For example, use of the n-word or threats of violence are assigned higher severity scores.
d. The AI system can take automated actions such as issuing warnings, suspending accounts temporarily, or permanently banning users based on these scores.
e. Detailed incident reports are generated for human moderators to review borderline cases and make final decisions.

### Content and Feature Updates:

a. The application is designed to receive monthly content updates to keep the user experience fresh and engaging.
b. These updates include new virtual backgrounds for video calls, interactive games, and additional features to enhance user interaction.
c. The content updates are automatically deployed through the app's backend system, ensuring all users receive the latest features without manual intervention.

### Example Scenario:

a. Two users, User A and User B, engage in a video call within the app. During the call, User B reports User A for using racial slurs.
b. The report is submitted through the app, and the AI system processes the report.
c. The Text Analysis Module detects the use of the n-word in the conversation log, flagging it as a high-severity incident.
d. The system cross-references previous reports against User A's unique ID and identifies a pattern of similar behavior.
e. Based on the severity score and repeat offense, the AI recommends a permanent ban.
f. A detailed report is generated and sent to human moderators, who review the incident and enforce the ban.

It should be understood that the present invention is an AI-enhanced dating application and platform that provides a robust solution for managing toxic behavior, ensuring a safer and more enjoyable user experience. By leveraging advanced AI technologies, the system effectively detects, reports, and mitigates inappropriate conduct, fostering a respectful and engaging environment for online dating. The system and platform also facilitate prudent matching based on time-of-day availability based on user preferences, making it more likely to find a match suitable to ones interests and personality, as well as a match suitable to meeting at a time-of-day at which both parties are available.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A dating application system comprising:
a frontend user interface (UI) configured for user interaction; and
a backend artificial intelligence (AI) engine comprising:
a Text Analysis module configured to scan messages for harmful language using natural language processing (NLP) algorithms;
a Video Analysis module configured to analyze live video streams for inappropriate visual content using computer vision techniques; and
a Report Management module configured to enable users to report inappropriate behavior and track reported incidents associated with user IDs.

2. The system of claim 1, wherein the Text Analysis module utilizes sentiment analysis and keyword matching to detect toxic language, and flags messages containing predefined keywords and phrases indicative of abusive or inappropriate behavior.

3. The system of claim 1, wherein the Video Analysis module employs object detection and gesture recognition algorithms to identify nudity, obscene gestures, and other forms of visual harassment, and flags video interactions containing such content for review.

4. The system of claim 1, wherein the Report Management module enables users to report inappropriate behavior through a user interface, specifying the type of behavior and providing additional details, and logs each report in a database associated with user IDs for comprehensive tracking.

5. The system of claim 1, further comprising:
a severity scoring mechanism of said text analysis module configured to assign severity scores to reported incidents based on predefined criteria and patterns, including the frequency and severity of inappropriate language or actions; and
an automated action mechanism configured to take actions such as issuing warnings, suspending accounts temporarily, or permanently banning users based on severity scores.

6. The moderation system of claim 5, wherein the severity scoring mechanism considers contextual factors such as the context of interactions and the history of reported incidents associated with user IDs.

7. The moderation system of claim 6, further comprising:
a content update mechanism, said content update mechanism comprising:
a backend system configured to receive monthly content updates; and
an automated deployment mechanism configured to deploy updates to the application's frontend UI, including new virtual backgrounds, interactive games, and additional features to enhance user interaction.

8. The content update mechanism of claim 7, wherein updates are deployed automatically to ensure all users receive the latest features without manual intervention.

9. A method for detecting and moderating inappropriate behavior in a dating application, comprising:
scanning messages for harmful language using NLP algorithms;
analyzing live video streams for inappropriate visual content using computer vision techniques;
enabling users to report inappropriate behavior through a user interface and tracking reported incidents associated with user IDs;
assigning severity scores to reported incidents based on predefined criteria and patterns; and
taking automated actions such as issuing warnings, suspending accounts temporarily, or permanently banning users based on severity scores.

10. The method of claim 9, further comprising: generating detailed incident reports for human moderators to review borderline cases and make final decisions on enforcement actions.

11. The method of claim 9, wherein scanning messages for harmful language comprises utilizing sentiment analysis and keyword matching to detect toxic language, and flagging messages containing predefined keywords and phrases indicative of abusive or inappropriate behavior.

12. The method of claim 9, wherein analyzing live video streams for inappropriate visual content comprises employing object detection and gesture recognition algorithms to identify nudity, obscene gestures, and other forms of visual harassment, and flagging video interactions containing such content for review.

13. The method of claim 9, wherein assigning severity scores to reported incidents further comprises considering contextual factors such as the context of interactions and the history of reported incidents associated with user IDs to determine the appropriate severity score for each reported incident.

14. The method of claim 11, wherein the AI employed by the platform facilitates automated recommendations to users, including recommending similar users whose dates typically last approximately the same length of time as those of the user, wherein the recommendations are displayed in a dedicated “recommendations tab” within the application interface.

15. The method of claim 14, wherein the AI utilizes user data and preferences to generate recommendations based on factors such as preferred date duration, common interests, geographic proximity, and language compatibility.

16. The method of claim 11, wherein the AI features include a chemistry match functionality that prioritizes requests from users with similar “chemistry” to that of the user when the user assumes a role of a time-setter, wherein “chemistry” is determined based on factors including but not limited to similar date durations, shared interests, geographic proximity, and language compatibility.

17. A method for facilitating dating matches between users online on a platform and mobile device application configured to mitigate inappropriate behavior, the method comprising:
a server computer hosting a platform to a domain;
users accessing the platform via the internet on a mobile device equipped with a camera and a microphone, referenced as user devices;
the server computer suggesting matches to users for dates according to an algorithm, the algorithm informed by an analysis of users' interests and time available for an online date;
wherein parameters of the algorithm dictate the suggestions of matches to users, the parameters including: gender, age, religion, ethnicity, location, and time available for a date;
a first user matching with a second user;
the second user agreeing to meet via an online date on the platform at a time posited by the first user and agreed to by the second user;
the first user meeting the second user during a video call;
AI of the platform monitoring the video in real-time and analyzing the speech, mannerisms, posture, and gestures of both the first user and the second user to detect signs of inappropriate behavior; and
AI flagging either the first user or the second user if inappropriate behavior is detected.

18. The method of claim 17, wherein inappropriate behavior includes, but is not limited to: typing or saying aloud predefined keywords indicating abuse and abusive posture as detected via AI visual analysis.
